(19) United States
(12) Patent Application Publication
(10) Pub. No.: US 2012/0082472 A1
(43) Pub. Date: Apr. 5, 2012

(54) IMAGE FORMING APPARATUS AND IMAGE FORMING METHOD

(75) Inventor: Chie Tonohiro, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/223,768

(22) Filed: Sep. 1, 2011

Related U.S. Application Data
(60) Provisional application No. 61/389,897, filed on Oct. 5, 2010.

(51) Int. Cl. G03G 15/16

(52) U.S. Cl. 399/66

(57) ABSTRACT

According to one embodiment, the image forming apparatus includes an image carrier the surface of which is charged at a predetermined potential, an exposure device which forms a latent image by exposing the surface of the image carrier, a developing unit which develops a toner image generated using color erasable toner on the latent image formed on the surface of the image carrier, a transfer unit which transfers the toner image to a recording medium, and a controller which controls an operation for transferring a toner image of the color erasable toner to a printed surface of the recording medium to cover a printed portion of the recording medium to which the color erasable toner has been fixed.

### CROSS-REFERENCE TO RELATED APPLICATION

This application is based upon and claims the benefit of U.S. Provisional Application 61/389,897, filed on Oct. 5, 2010; the entire contents of which are incorporated herein by reference.

### FIELD

Embodiments described herein relate generally to an image forming apparatus and an image forming method.

### BACKGROUND

In the related art, there is known an image removal apparatus which removes an image on a sheet which is formed using color erasable toner, so as to reuse the sheet when forming a subsequent image. With the color erasable toner, color erasing is performed such that the connection between a pigment and a color former in the toner is lost by heating the toner. In an image forming apparatus in the related art, for example, it is necessary to heat the sheet at 120° C. to 150° C. for color erasing of a toner image.

### BRIEF DESCRIPTION OF THE DRAWINGS

FIG. 1 is an exemplary diagram which shows a schematic configuration of an image removal apparatus provided with an image forming apparatus according to a first embodiment.

FIG. 2 is an exemplary block diagram which shows a configuration of a control system of the image removal apparatus according to the first embodiment.

FIG. 3 is an exemplary diagram which describes uneven color erasing according to the first embodiment.

FIG. 4 is an exemplary diagram which describes a color erasing method according to the first embodiment.

FIG. 5 is an exemplary flow chart which shows an operation of an image forming apparatus according to a second embodiment.

FIG. 6 is an exemplary diagram which describes a color erasing method according to the second embodiment.

FIG. 7 is an exemplary flow chart which shows an operation of the image forming apparatus according to a third embodiment.

FIG. 8 is an exemplary flow chart which shows an operation of an image forming apparatus according to a fourth embodiment.

FIG. 9 is an exemplary diagram which shows an image pattern according to the fourth embodiment.

FIG. 10 is an exemplary diagram which shows a schematic configuration of an image removal apparatus provided with an image forming apparatus according to a fifth embodiment.

### DETAILED DESCRIPTION

In general, according to one embodiment, the image forming apparatus includes an image carrier the surface of which is charged at a predetermined potential, an exposure device which forms a latent image by exposing the surface of the image carrier, a developing unit which develops a toner image generated using color erasable toner on the latent image formed on the surface of the image carrier, a transfer unit which transfers the toner image to a recording medium, and a controller which controls an operation for transferring a toner image of the color erasable toner to a printed surface of the recording medium to cover a printed portion of the recording medium to which the color erasable toner has been fixed.

Hereinafter, embodiments of the invention will be described.

### First Embodiment

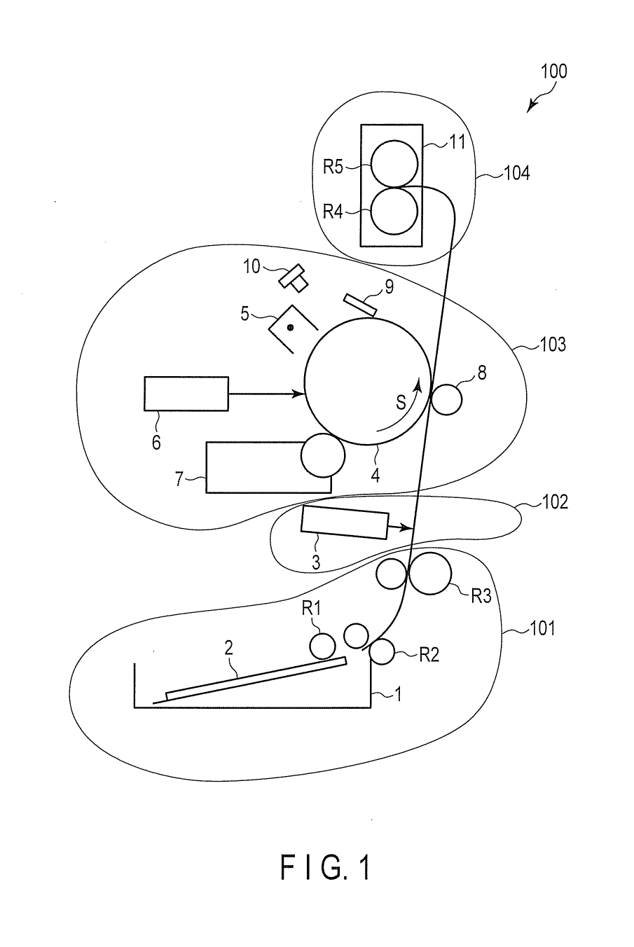

FIG. 1 is an exemplary diagram which shows a schematic configuration of an image forming apparatus according to a first embodiment.

The image forming apparatus 100 is provided with a sheet feeding unit 101, an image reading unit 102, an image forming unit 103, and an image fixing unit (a color erasing unit) 104.

The sheet feeding unit 101 supplies a sheet on which printing is already performed using color erasable toner (hereinafter, referred to as color erasing toner), to the image forming unit 103. The image reading unit 102 reads a printed state of the sheet. The image forming unit 103 further transfers the color erasing toner to the supplied sheet and transports it to the fixing unit 104. The fixing unit 104 fixes the image of the color erasing toner, which is transferred to the sheet, to the sheet, by applying heat. The fixing unit 104 performs a fixing operation and removes an image of color erasing toner on the sheet by applying heat of a predetermined temperature or higher. Subsequently, configurations and functions of the image forming apparatus 100 will be described.

When an image erasing operation is started, a sheet 2 on which printing is already performed using the color erasing toner which is accommodated in a sheet feeding tray 1, is taken out from a sheet feeding roller R1. The sheet 2 is transported using a transport roller R2. In the transporting process, the reading unit 102 reads a printed surface of the sheet and specifies a portion where printing is performed already. Printing is performed using the color erasing toner in the image forming unit 103 according to the specified printed portion.

The image forming unit 103 is provided with a photo conductive drum 4, a charger 5, a laser exposure device 6, a developing unit 7, a transfer roller 8, a cleaner 9, and a neutralizing LED 10.

The photo conductive drum 4 is an OPC (Organic Photo Conductor) which has an organic photo conductive layer on a surface of a supporting member. The photo conductive drum 4 is driven in a direction of an arrow S at a predetermined rim speed.

The charger 5 uniformly and sequentially charges the photo conductive drum 4 at a predetermined potential, according to a rotation of the photo conductive drum 4. The laser exposure device 6 irradiates the photo conductive drum 4 with laser light at an irradiating position on the charged photo conductive drum 4 according to image information which will be explained later. Further, an electrostatic latent image is formed on the photo conductive drum 4.

The developing unit 7 uses a heterogeneity developer which is a mixture of color erasing toner and a magnetic carrier. A developing bias of a predetermined potential is applied to a developing roller of the developing unit 7, the electrostatic latent image on the photo conductive drum 4 is developed due to a reversal processing, and a toner image is formed on the photo conductive drum 4.

Meanwhile, the sheet 2 is fed from a sheet feeding tray 1. The sheet 2 is transported to a position of the transfer roller 8 in synchronization with a formation of the toner image on the photo conductive drum 4, using the resist roller R3. The toner image on the photo conductive drum 4 is transferred to the sheet 2.

The fixing unit (the color erasing unit) 104 is disposed at the rear of the image forming unit 103. The sheet 2 to which the toner image is transferred, is sent to the fixing unit (the color erasing unit) 104 after being separated from the photo conductive drum 4. The fixing unit (the color erasing unit) 104 heats and presses the sheet 2 which is a recording medium. The image of the color erasing toner on the sheet, which is formed, loses its color when the image is heated at a predetermined temperature or at a temperature higher than the predetermined temperature, and the connection between a pigment of the color erasing toner and a color former is lost due to the heat. The fixing unit (the color erasing unit) 104 includes a roller R4 and a roller R5 which are a pressure rotation body, and is in press-contact with the roller R4. The sheet 2 is inserted between the roller R4 and the roller R5, and the toner image thereon is heated and pressed. In this manner, the image of the color erasing toner which is originally printed on the sheet 2 is erased at the same time as a newly transferred image of the color erasing toner is fixed and erased. The sheet 2 is discharged in a predetermined direction after the color of the toner image of the color erasing toner is erased, in the fixing unit (the color erasing unit) 104.

In addition, in the photo conductive drum 4, the cleaner 9 cleans remaining toner, remaining charges are removed using the neutralizing LED 10, and the image forming process is ended.

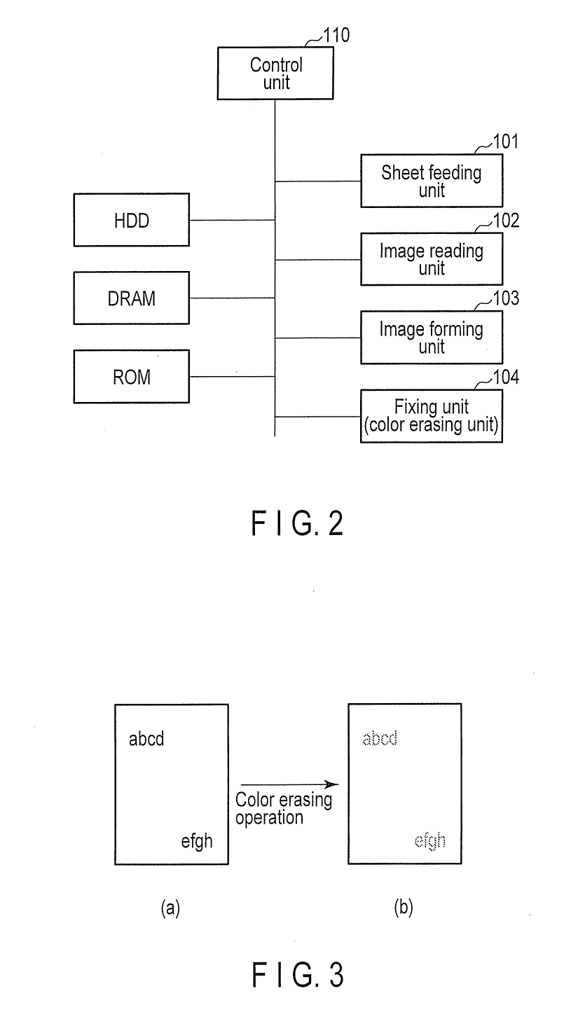

FIG. 2 is an exemplary block diagram which shows a configuration of a control system of the image forming apparatus 100 according to the first embodiment.

The image forming apparatus 100 further includes a control unit 110, a ROM, a DRAM, and an internal storage device (HDD) along with the above-mentioned sheet feeding unit 101, image reading unit 102, image forming unit 103, and fixing unit (the color erasing unit) 104. In addition, all of the units are connected to each other through a system bus.

The control unit 110 controls each of the units, which are connected to each other through the system bus. The ROM stores a variety of control programs which are necessary when the image forming apparatus 100 is operated. In the ROM, each program for controlling an image forming operation and an image removing operation which will be described later, is stored. An execution of each program is controlled by the control unit 110. The DRAM is a buffer memory which temporally stores data which is generated when executing each program.

Next, a color erasing method according to the first embodiment will be described.

As described above, in the embodiment, when color erasing is performed on the fixed image, the color erasing toner is further printed on the printed surface of the sheet.

FIG. 3 is an exemplary diagram which describes uneven color erasing according to the first embodiment.

FIG. 3(a) is an example of a printed character or an image which is printed using the color erasing toner. When color erasing is going to be performed on the image on the sheet using the image forming apparatus in the related art, there may be a case where uneven color erasing is generated. FIG. 3(b) shows an example of uneven color erasing. Uneven color erasing is a state where a part of a shape or a part of a characterized portion of an original residual image is visible, even though the concentration thereof is thin.

Meanwhile, the color erasing process is a phenomenon where the color of the toner image is removed when a connection between the pigment of the color erasing toner and the color former is disconnected due to heat. That is, the toner on the sheet is not removed, but changed to be transparent. Accordingly, even though the toner becomes transparent, there is a possibility that it can be visible as uneven color erasing due to the reflective characteristics.

In this manner, when a sheet on which the original image has been erased is used, it is necessary to secure the visibility of a newly printed image. Accordingly, it is necessary to consider a measure which changes the original image such that a part of the shape or a part of the characterized portion of the original image is not seen.

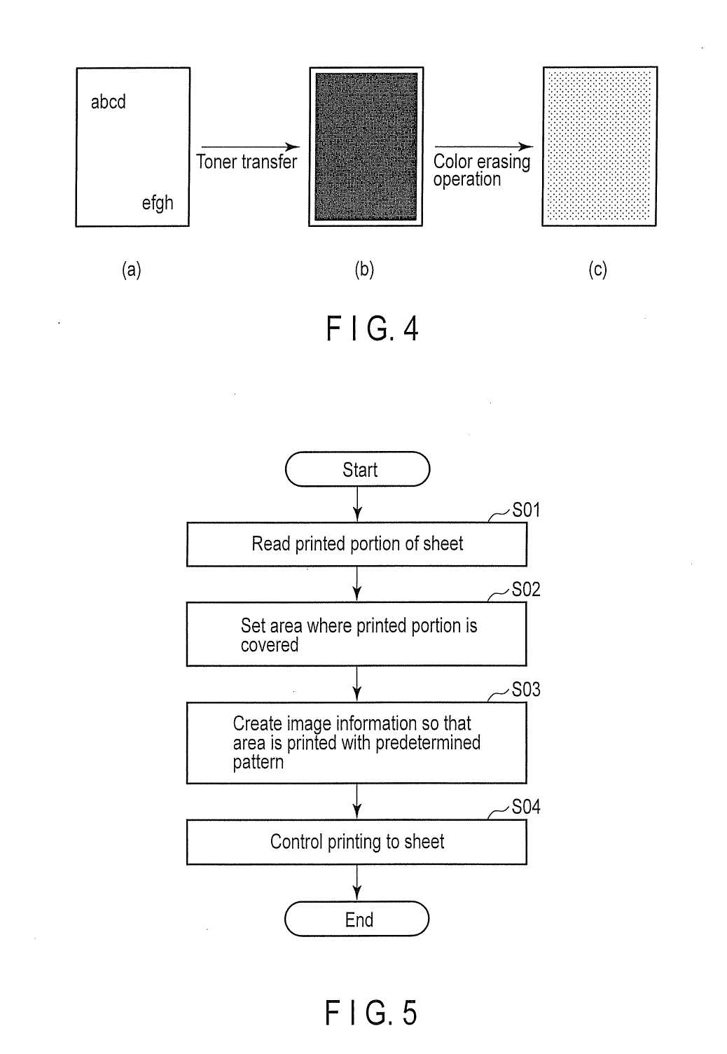

FIG. 4 is an exemplary diagram which describes a color erasing method according to the first embodiment.

As shown in FIG. 4, in the image forming unit 103, the color erasing toner is transferred to the entire surface of the sheet 2. Further, the fixing unit (the color erasing unit) 104 performs the color erasing operation on the sheet 2 to which the color erasing toner is transferred to the entire surface thereof. As a result, a part of the shape or a part of the characterized portion of the original image becomes invisible, and it is possible to secure the visibility of the newly printed image. In addition, a pattern of the color erasing toner to be transferred to the entire surface of the sheet 2 may be a random pattern or a uniform pattern such that the visibility of the newly printed image can be secured. Further, it is desirably a uniform pattern; however, the color or types of the color erasing toner to be used are not particularly limited.

### Second Embodiment

In a second embodiment, a pattern of a color erasing toner to be transferred to a sheet 2 is different from that of the first embodiment, in an image forming unit 103. Accordingly, the same portions as those of the first embodiment will be denoted by the same reference numerals, and detailed descriptions thereof will be omitted.

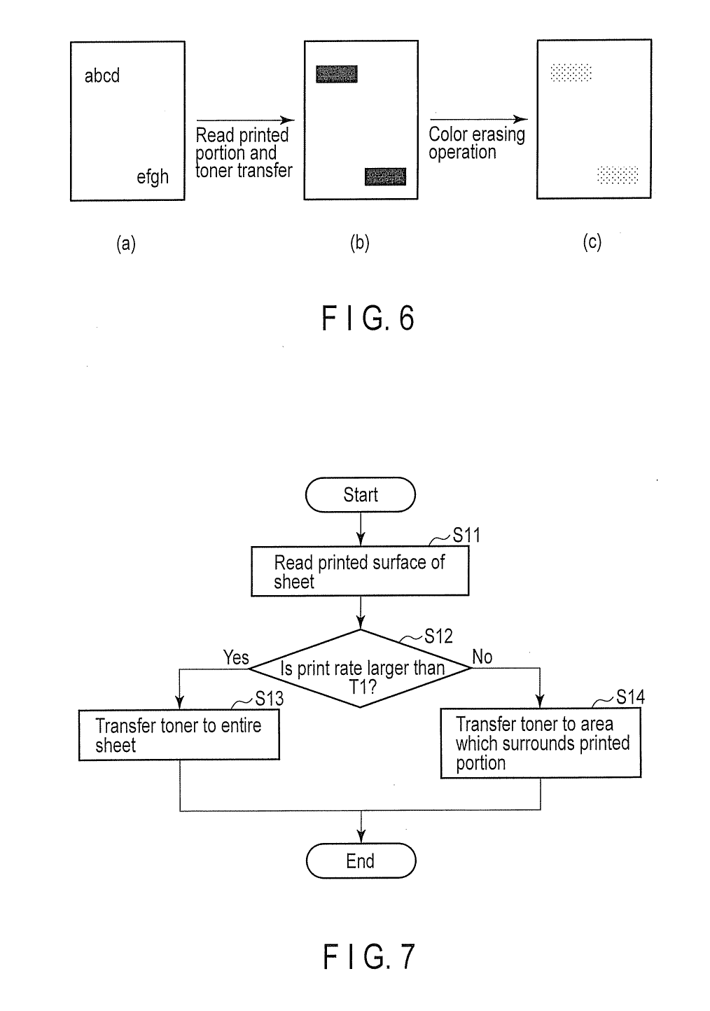

FIG. 5 is an exemplary flow chart which shows an operation of an image forming apparatus 100 according to the second embodiment. FIG. 6 is an exemplary diagram which describes a color erasing method according to the second embodiment. The operation of the image forming apparatus 100 will be described with reference to FIGS. 5 and 6.

In Act 01, an image reading unit 102 reads a printed surface of a sheet 2 which is extracted by a sheet feeding roller R1 and transported. FIG. 6(a) shows a state of the read printed surface. In Act 02, a control unit 110 sets an area where a printed portion of the printed surface (hereinafter, referred to as a printed portion) is covered. In FIG. 6(b), two areas are set. In addition, when each printed portion is within a predetermined distance, it may be considered as a continuous printed portion, and be set as one area. Further, the area is not limited to a rectangular shape, but may be a circular shape, an oval shape, or may be surrounded by an arbitrary looped curve.

In Act 03, a control unit 110 creates image information so that the set area is printed with a predetermined pattern. The predetermined pattern may be a random pattern or a uniform pattern. For example, the predetermined pattern may be a solid pattern, a half tone pattern, a parallel line pattern, or the like. In Act 04, the control unit 110 controls each unit of the image forming unit 103 so that color erasing toner is printed on the sheet 2, on the basis of the image information.

FIG. 6(c) shows the printed surface of the sheet 2 to which the toner image is erased in a fixing unit (a color erasing unit) 104. Even though there still remains uneven color erasing in the printed portion after erasing, a characteristic shape or the like of an original image is not shown, because a toner layer in uneven color erasing is made uniform. Accordingly, it is possible to prevent a printed image in the subsequent printing process from being invisible.

### Third Embodiment

In a third embodiment, a method of transferring color erasing toner to a sheet 2 is different from that of the first embodiment, in an image forming unit 103. Accordingly, the same portions as those of the first embodiment will be denoted by the same reference numerals, and detailed descriptions thereof will be omitted.

FIG. 7 is an exemplary flow chart which shows an operation of an image forming apparatus 100 according to the third embodiment.

In Act 11, an image reading unit 102 reads a printed surface of a sheet 2 which is extracted by a sheet feeding roller R1 and transported. In Act 12, a control unit 110 checks whether or not a print rate of the read printed surface is larger than the predetermined value T1. The print rate is a value which is shown by the following expression (1),

Print rate=(area where toner is occupying on sheet)/(total area of sheet) Expression (1)

When the print rate is larger than the predetermined value T1 (Yes, in Act 12), in Act 13, the control unit 110 controls the image forming unit 103 to transfer color erasing toner to the entire surface of the sheet 2, similarly to the first embodiment. When the print rate is equal to or smaller than the predetermined value T1 (No, in Act 12), in Act 14, the control unit 110 controls the image forming unit 103 so as to transfer the color erasing toner to an area surrounding the printed portion, similarly to the second embodiment.

When the print rate is high, there is a case where a plurality of areas surrounding the printer portion is present in the sheet. In such a case, conversely, there is a high possibility that an image printed in the next printing process will become difficult to see, because color erasing toner is transferred to the area.

In addition, in Act 12, the printing method is changed by the print rate; however, the printing method may be changed using the number of areas surrounding the printed portion. That is, if the number of areas is equal to or more than a predetermined number, the color erasing toner is transferred to the entire surface of the sheet 2. If the number of areas is smaller than the predetermined number, the color erasing toner is transferred to the area surrounding the printed portion.

### Fourth Embodiment

In a fourth embodiment, a method of transferring color erasing toner to a sheet 2 is different from that of the first embodiment, in an image forming unit 103. Accordingly, the same portions as those of the first embodiment will be denoted by the same reference numerals, and detailed descriptions thereof will be omitted.

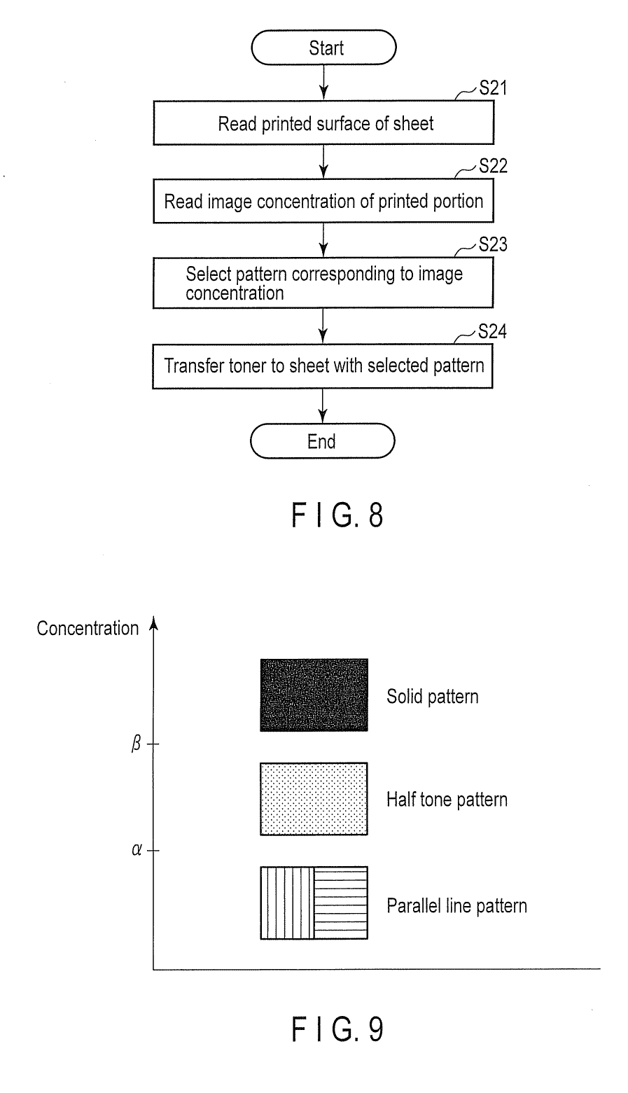

FIG. 8 is an exemplary flow chart which shows an operation of an image forming apparatus 100 according to the fourth embodiment.

In Act 21, an image reading unit 102 reads a printed surface of the sheet 2 which is taken out by a sheet feeding roller R1 and transported. In Act 22, the control unit 110 extracts the image concentration of the printed portion on the read printed surface. Here, the concentration of the image on the printed portion to be extracted may be the maximum value of the image concentration of each printed portion or may be a mean value of each printed portion. The image concentration can correspond to a reflected luminance of light irradiated to the image. That is, when the reflected luminance is high, the image concentration is low and when the reflected luminance is low, the image concentration is high. In Act 23, the control unit 110 selects an image pattern according to the image concentration.

FIG. 9 is an exemplary diagram which shows an image pattern according to the fourth embodiment.

For example, when the image concentration is equal to or lower than α, a thin parallel line pattern is selected as an image pattern. When the image concentration is higher than α and equal to or lower than β, a half tone pattern is selected. When the image concentration is higher than β, a solid pattern is selected. That is, when the image concentration is high, a pattern with high concentration or a pattern with high image density is selected. When the image density is low, a pattern with low concentration or a pattern with low image density is selected.

In Act 24, the control unit 110 transfers color erasing toner to the sheet using the selected pattern. In addition, when transferring the color erasing toner, the toner may be transferred to the entire surface of the sheet or may be transferred to the printed portion. In addition, the portion to be transferred may be selected according to the print rate, similarly to the third embodiment.

In the embodiments described above, the image forming unit 103 is an electrographic printing unit (including the photo conductive drum 4, the charger 5, the laser exposure device 6, the developing unit 7, the transfer roller 8, the cleaner 9, and the neutralizing LED 10). However, the present invention does not have to use color erasing toner but may use color erasing ink instead. In other words, the image forming unit 103 of the embodiment shown in FIG. 1 may be replaced with an inkjet printing unit (inkjet head).

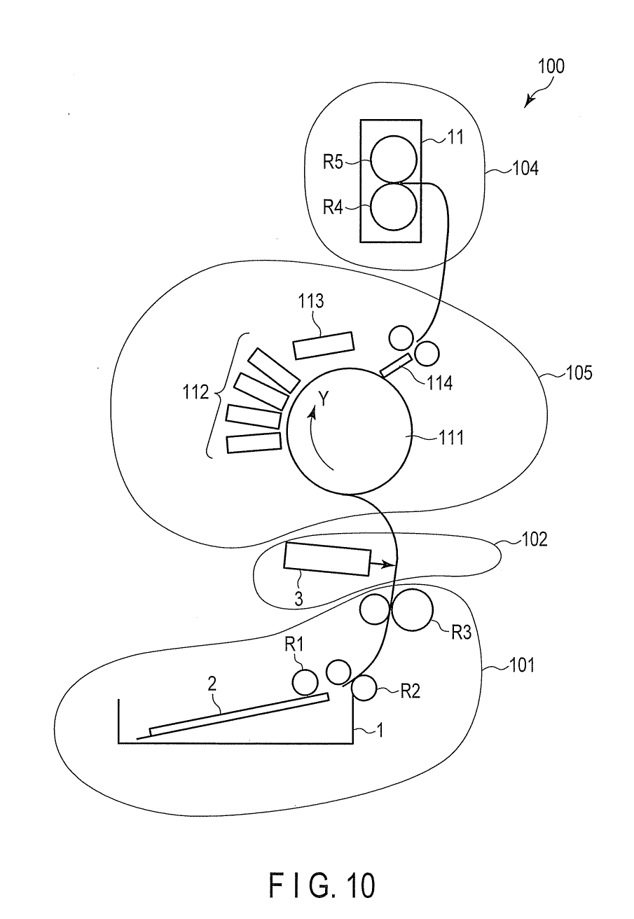

FIG. 10 is an exemplary diagram which shows a schematic configuration of an image removal apparatus provided with an image forming apparatus according to a fifth embodiment.

In the fifth embodiment, an inkjet printing unit 105 is provided in place of the image forming unit 103 shown in FIG. 1. The inkjet printing unit 105 comprises a drum 111 (which is an endless device), a line head unit 112, a drying unit 113 and a sheet separation unit 114.

The drum 111 can rotate at a predetermined circumferential speed and is configured to attract and hold a sheet P on the outer circumferential surface thereof. The line head unit 112 comprises line heads 112-C, 112-M, 112-Y and 112-K for respective colors of C (Cyan), M (Magenta), Y (Yellow) and K (key color: Black). The line heads 112-C, 112-M, 112-Y and 112-K are arranged in a direction orthogonal to the rotating direction Y of the drum 111 (i.e., the main scanning direction), and can perform printing in the main scanning direction at a time.

The drying unit 113 dries the ink on sheet P by blowing air or heated air against sheet P. The sheet separation unit 114 separates sheet P (on which an image is formed and the ink is dried) from the drum 111 by means of a separation claw, and supplies the sheet toward a downward portion of a sheet supply path.

Since the operation of the image forming apparatus of the fifth embodiment is similar to those of the second to fourth embodiments, a detailed description of the operation will be omitted.

In addition, each function which is described in the above described embodiments may be configured using hardware, or may be realized by allowing a computer to read a program in which each function is described, using software. In addition, each function may be configured by appropriately selecting either the software or the hardware.

Further, each function may be realized by allowing the computer to read programs which are stored in a recording medium (not shown). Here, if the recording medium according to the embodiment is a recording medium which can record programs and can be read by the computer, any type of recording format thereof may be used.

Further, in the embodiment, the fixing unit of the image forming apparatus has a color erasing function of the color erasing toner or color erasing ink; however, the fixing unit may not have the color erasing function. In such a case, when the image of the color erasing toner or color erasing ink is removed, the image of the color erasing toner may be removed using a removal apparatus which includes a sheet feeding unit and a color erasing unit and does not include an image forming unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image carrier the surface of which is charged at a predetermined potential;
an exposure device which forms a latent image by exposing the surface of the image carrier;
a developing unit which develops a toner image generated using color erasable toner on the latent image formed on the surface of the image carrier;
a transfer unit which transfers the toner image to a recording medium; and
a controller which controls an operation for transferring a toner image of the color erasable toner to a printed surface of the recording medium, to cover a printed portion of the recording medium to which the color erasable toner has been fixed.

2. The apparatus according to claim 1:
wherein, the controller controls an operation for transferring a toner image of the color erasable toner to the entire surface of the printed surface of the recording medium to which the color erasable toner has been fixed.

3. The apparatus according to claim 2:
wherein, the toner image which is transferred to the entire surface of the printed surface of the recording medium has a uniform image pattern.

4. The apparatus according to claim 3:
wherein, the uniform image pattern is a solid pattern, a half tone pattern, or a parallel line pattern.

5. The apparatus according to claim 1:
wherein, the controller sets an area where the printed portion of the recording medium to which the color erasable toner has been fixed is covered,
wherein the controller controls an operation for transferring a toner image of the color erasable toner to the area of the recording medium.

6. The apparatus according to claim 5:
wherein, the toner image which is transferred to the area of the recording medium has a uniform image pattern.

7. The apparatus according to claim 6:
wherein, the uniform image pattern is the solid pattern, the half tone pattern, or the parallel line pattern.

8. The apparatus according to claim 1:
wherein, when a print rate of the recording medium to which the color erasable toner has been fixed is equal to or more than a predetermined value, the controller controls an operation for transferring a toner image of the color erasable toner to the entire surface of the printed surface of the recording medium to which the color erasable toner has been fixed,
wherein, when the print rate of the recording medium to which the color erasable toner has been fixed is lower than the predetermined value, the controller sets an area where the printed portion of the recording medium to which the color erasable toner has been fixed is covered, and controls an operation for transferring a toner image of the color erasable toner to the area of the recording medium.

9. The apparatus according to claim 8:
wherein, the toner image transferred to the recording medium has a uniform image pattern.

10. The apparatus according to claim 9:
wherein, the uniform image pattern is the solid pattern, the half tone pattern, or the parallel line pattern.

11. The apparatus according to claim 1:
wherein, the controller sets an area where the printed portion of the recording medium to which the color erasable toner has been fixed is covered,
wherein, when the number of areas is equal to or larger than a predetermined value, the controller controls an operation which transfers the toner image of the color erasable toner to the entire printed surface of the recording medium to which the color erasable toner has been fixed,
wherein, when the number of areas is smaller than the predetermined value, an operation for transferring the toner image of the color erasing toner to the area of the recording medium is controlled.

12. The apparatus according to claim 1:
wherein, the controller obtains a concentration of the printed portion of the recording medium to which the color erasable toner has been fixed; allows a different plurality of image patterns to correspond to each other in a manner that a concentration of the image pattern is proportional to the concentration of the printed portion; and controls an operation which transfers the toner image of the color erasable toner to the printed surface of the recording medium in a manner that the printed portion of the recording medium is covered using the image pattern which is made to correspond to the concentration of the printed portion.

13. The apparatus according to claim 9:
wherein, the different plurality of image patterns is the solid pattern, the half tone pattern, or the parallel line pattern.

14. An image forming method comprising:
charging a surface of an image carrier at a predetermined potential;
forming a latent image by exposing the surface of the image carrier in a manner that a printed portion on a recording medium, to which color erasable toner has been fixed, is covered;
developing a toner image using the color erasable toner on the latent image formed on the surface of the image carrier; and
transferring the toner image to the recording medium to which the color erasable toner has been fixed.

15. The method according to claim 14, further comprising:
transferring the toner image of the color erasable toner to the entire surface of the printed surface of the recording medium to which the color erasable toner has been fixed.

16. The method according to claim 14, further comprising:
setting an area, where the printed portion of the recording medium to which the color erasable toner has been fixed is covered, and
transferring the toner image of the color erasable toner to the area of the recording medium.

17. The method according to claim 14, further comprising:
when a print rate of the recording medium to which the color erasable toner has been fixed is equal to or higher than a predetermined value, transferring the toner image of the color erasable toner to the printed portion of the recording medium to which the color erasable toner has been fixed; and
when the print rate of the recording medium to which the color erasable toner has been fixed is smaller than the predetermined value, setting the area, where the printed portion of the recording medium to which the color erasable toner has been fixed is covered, and transferring the toner image of the color erasable toner to the area of the recording medium.

18. The method according to claim. 14, further comprising:
setting the area, where the printed portion of the recording medium to which the color erasable toner has been fixed is covered;
when the number of the areas is equal to or larger than a predetermined value, transferring the toner image of the color erasable toner to the entire printed surface of the recording medium to which the color erasable toner has been fixed; and
when the number of the areas is smaller than the predetermined value, transferring the toner image of the color erasable toner to the area of the recording medium.

19. The method according to claim 14, further comprising:
obtaining the concentration of the printed portion of the recording medium to which the color erasable toner has been fixed is obtained;
allowing different pluralities of image patterns to correspond to each other in a manner that the concentration of the image pattern is proportional to the concentration of the printed portion; and
transferring the toner image of the color erasable toner is transferred to the printed portion of the recording medium in a manner that the printed portion of the recording medium is covered with the image pattern which is made to correspond to the concentration of the printed portion.

20. An image forming method comprising:
feeding a recording medium on which printing has been performed by use of color erasable ink; and
performing printing by use of the color erasable ink such that a printed portion on the recording medium is covered.

21. The method according to claim 20, further comprising:
performing printing on an entire printing surface of the recording medium on which the color erasable ink has been printed, by use of the color erasable ink.

22. The method according to claim 20, further comprising:
setting an area where the printed portion of the recording medium to which the color erasable ink has been printed is covered, and
perform printing in the area of the recording medium by use of the color erasable ink.

23. The method according to claim 20, further comprising:
when a print rate of the recording medium to which the color erasable ink has been printed is equal to or higher than a predetermined value, performing printing on an entire printing surface of the recording medium on which the color erasable ink has been printed, by use of the color erasable ink; and
when the print rate of the recording medium to which the color erasable ink has been fixed is smaller than the predetermined value, setting an area where the printed portion of the recording medium to which the color erasable ink has been printed is covered, and performing printing in the area of the recording medium by use of the color erasable ink.

24. The method according to claim 20, further comprising:
setting areas where the printed portion of the recording medium to which the color erasable ink has been printed is covered;
when the number of areas is equal to or larger than a predetermined value, performing printing on an entire printing surface of the recording medium to which the color erasable ink has been printed, by use of the color erasable ink; and
when the number of areas is smaller than the predetermined value, performing printing in the areas on the recording medium by use of the color erasable ink.

25. The method according to claim 20, further comprising:
obtaining a concentration of the printed portion of the recording medium to which the color erasable ink has been printed;
allowing different image patterns to correspond to one another such that concentrations of the image patterns are proportional to the concentration of the printed portion; and performing printing on the printing surface of the recording medium by use of the color erasable ink in a manner that the printed portion on the recording medium is covered with an image pattern corresponding to the printed portion.
